(19) United States
(12) Patent Application Publication
(10) Pub. No.: US 2026/0328234 A1
(43) Pub. Date: Oct. 22, 2026

(54) VIBRATION RESISTANT FASTENER

(71) Applicant: HOWMET AEROSPACE INC., Pittsburgh, PA (US)

(72) Inventor: Andrew Frost, Telford-Shropshire (GB)

(21) Appl. No.: 19/709,583

(22) Filed: Jun. 16, 2026

Related U.S. Application Data
(63) Continuation of application No. PCT/US2024/060310, filed on Dec. 16, 2024.
(60) Provisional application No. 63/612,160, filed on Dec. 19, 2023.

(51) Int. Cl. F16B 5/02; F16B 39/282

(52) U.S. Cl. CPC F16B 5/0275; F16B 39/282

(57) ABSTRACT

A fastener may include an elongated shank having a first end that includes a first threaded portion. A second end is opposite the first end. The second end includes a grooved portion. The first threaded portion includes at least one protrusion. The at least one protrusion is configured to engage at least a corresponding one of internal threads of a component in response to a tensile force applied to the second end.

### CROSS-REFERENCE TO RELATED APPLICATIONS

This patent application is a continuation of International Patent Application No. PCT/US2024/060310, entitled “VIBRATION RESISTANT FASTENER,” filed Dec. 16, 2024, which claims priority to U.S. Provisional Patent Application No. 63/612,160, entitled “VIBRATION RESISTANT FASTENER,” filed Dec. 19, 2023. Each of the above-identified patent applications are hereby incorporated by reference in their entirety.

### FIELD

This disclosure relates generally to fasteners. More particularly, this disclosure relates to a vibration resistant fastening system.

### BACKGROUND

Conventional nuts and bolts are convenient to use, but both are subject to loosening under severe vibrational loading. Moreover, the bolts' threads can create stress concentrations and do not have the necessary fatigue strength to hold up against high spike loads.

### SUMMARY

Broadly, the present disclosure relates to fasteners, fastening systems, and combinations thereof having one or more of a threaded portion, a grooved portion, at least one protrusion, or a combination thereof. The at least one protrusion may be configured to, for instance, engage at least a corresponding one of internal threads of a component in response to a tensile force applied to the second end. Such fasteners, fastening systems, or combinations thereof, may be useful, for instance, in environments including severe vibrational loads. For example, environments utilizing large machinery that may induce vibrations that could lead to vibrational loosening.

In some embodiments, a fastener includes an elongated shank. In some embodiments, the elongated shank includes a first end and a second end opposite the first end. In some embodiments, the first end includes a first threaded portion. In some embodiments, the second end includes a grooved portion. In some embodiments, the first threaded portion includes at least one protrusion. In some embodiments, the at least one protrusion is configured to engage at least a corresponding one of internal threads of a component in response to a tensile force applied to the second end.

In some embodiments, the first threaded portion is rolled.

In some embodiments, the first threaded portion includes a non-standard threading to provide clearance between threads of the first threaded portion and the internal threads of the component.

In some embodiments, the at least one protrusion is disposed on at least one flank side of threads of the first threaded portion.

In some embodiments, the internal threads of the component are non-standard to provide clearance between threads of the first threaded portion and the internal threads of the component.

In some embodiments, the at least one protrusion includes a plurality of protrusions on a single flank side of threads of the first threaded portion.

In some embodiments, the grooved portion includes at least one of a helical profile or an annular profile.

In some embodiments, the at least one protrusion includes a plurality of protrusions on a plurality of flank sides of threads of the first threaded portion.

In some embodiments, the plurality of protrusions are configured to embed into the internal threads of the component.

In some embodiments, the at least one protrusion includes a plurality of protrusions, wherein the plurality of protrusions are not aligned longitudinally with one another.

In some embodiments, a fastener system includes an elongated shank including a first end and a second end opposite the first end. In some embodiments, the first end includes a first threaded portion. In some embodiments, the second end includes a grooved portion. In some embodiments, the first threaded portion includes at least one protrusion. In some embodiments, a collar is configured to fit over the second end and to provide a clamping force to a workpiece in conjunction with a threaded component. In some embodiments, the at least one protrusion is configured to engage at least a corresponding one of internal threads of the threaded component in response to a tensile force applied to the second end.

In some embodiments, the grooved portion includes annular threads or helical threads.

In some embodiments, the at least one protrusion is disposed on at least one flank side of threads of the first threaded portion.

In some embodiments, an installation tool is configured to engage the second end.

In some embodiments, the first threaded portion includes a non-standard threading to provide clearance between threads of the first threaded portion and the internal threads of the component.

In some embodiments, the internal threads of the component are non-standard to provide clearance between threads of the first threaded portion and the internal threads.

In some embodiments, the at least one protrusion is configured to embed into the internal threads.

In some embodiments, the at least one protrusion includes a plurality of protrusions. In some embodiments, the plurality of protrusions are not aligned longitudinally with one another.

In some embodiments, a method includes obtaining a fastener and engaging the second end of the elongated shank. In some embodiments, the method includes pulling the fastener with an installation tool. In some embodiments, the method includes engaging the at least one protrusion with at least a corresponding one of internal threads of the component.

In some embodiments, the method includes deactivating the installation tool to release from the second end of the elongated shank when the fastener has been installed and a plurality of workpieces are clamped together.

In some embodiments, the method includes threading the first end of the fastener to the component prior to pulling the fastener with the installation tool.

In some embodiments, clearance is present between internal threads of the component and the threads of the first threaded portion prior to engaging the at least one protrusion with the at least a corresponding one of internal threads of the component.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a schematic view of a fastener, according to some embodiments.

FIG. 2 is a schematic view of the fastener of FIG. 1 in a pre-installed state, according to some embodiments.

FIG. 3 is a schematic view of the fastener of FIG. 1 in an installed state, according to some embodiments.

FIG. 4 is a schematic view of a threaded portion of the fastener of FIG. 1, according to some embodiments.

FIG. 5 is a schematic view of a fastener, according to some embodiments.

FIG. 6 is a flowchart of a method for installing a fastener, according to some embodiments.

Like reference numbers represent the same or similar parts throughout.

### DETAILED DESCRIPTION

Conventional nuts and bolts are convenient to use, but both are subject to loosening under severe vibrational loading. Moreover, the bolts' threads can create stress concentrations and do not have the necessary fatigue strength to hold up against high spike loads. Embodiments of this disclosure are directed to fasteners and fastener systems that resist vibrational loosening.

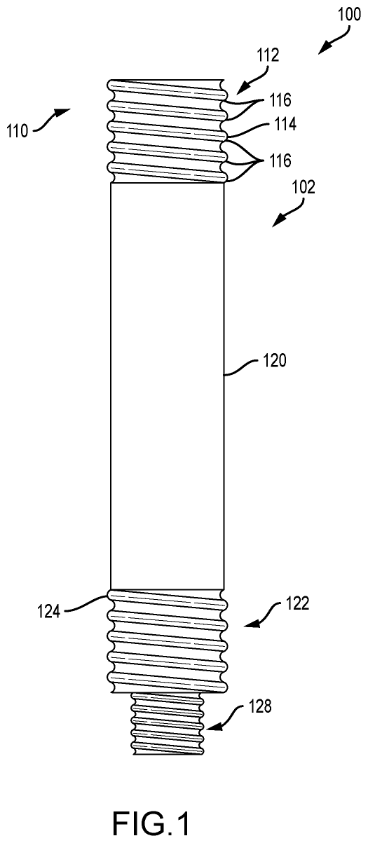

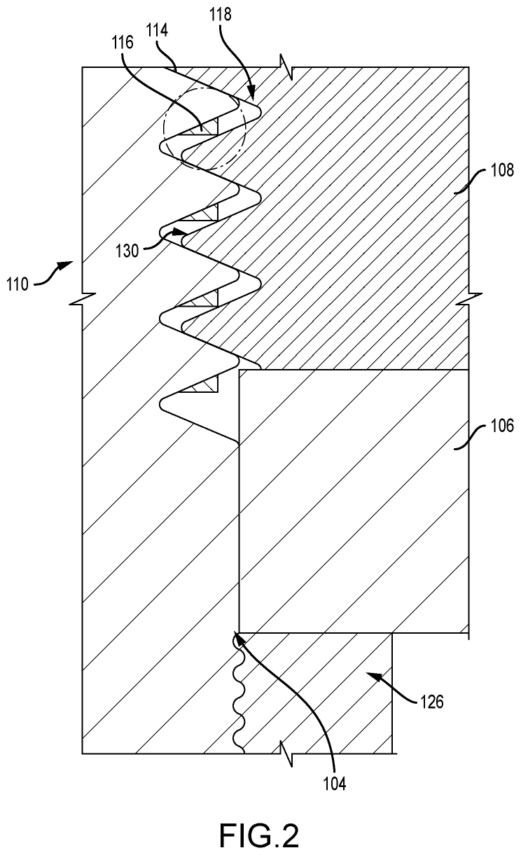

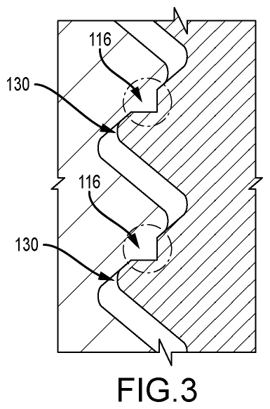

FIG. 1 is a schematic view of a fastener 100, according to some embodiments. FIG. 2 is a schematic view of the fastener 100 in a pre-installed state, according to some embodiments. FIG. 3 is a schematic view of the fastener 100 in an installed state, according to some embodiments. For simplicity of this disclosure, FIGS. 1-3 will be referenced collectively unless specific indication to the contrary.

In some embodiments, the fastener 100 is a lockbolt. In some embodiments, the fastener 100 is a pin member. In some embodiments, the fastener 100 includes a head (not shown). In some embodiments, the fastener 100 is a threaded rod. In some embodiments, the fastener 100 can be used, for example, in applications such as those utilizing large machinery. Such environments often include machinery that may induce vibrations. The fastener 100 can reduce a likelihood that the fastener (or a portion thereof) is vibrated loose, which can cause the workpiece being held by the fastener 100 to release. The fastener 100 can provide a more reliable connection than prior fasteners, especially in high vibration environments. In some embodiments, the fastener 100 can be made of steel, stainless steel, aluminum, alloys thereof, or the like.

The fastener 100 includes an elongated shank 102. The elongated shank 102 is configured to extend through an opening 104 of an application or workpiece 106 to which the elongated shank 102 is configured to be secured via the fastener 100 and a component 108. In some embodiments, the application or workpiece 106 can include a plurality of workpieces configured to be secured together. In some embodiments, the application can be a mounting point or the like.

The elongated shank 102 includes a first end 110 including a threaded portion 112. The threaded portion 112 includes external threads 114. In some embodiments, the threaded portion 112 includes a plurality of protrusions 116 extending from at least some of the threads 114 in the threaded portion 112. In some embodiments, the threaded portion 112 can be configured to engage receiving threads 118 of the component 108. The component 108 can be, for example, a nut in some embodiments. In some embodiments, the component 108 is a collar. In some embodiments, the component 108 is a lock collar. In some embodiments, the component 108 is a machine or other equipment piece having a threaded bore. In some embodiments, the fastener 100 can be used to fasten two workpieces together. In some embodiments, the fastener 100 can be used to fasten a machine or other piece of equipment to a surface such as, but not limited to, a work table or the like.

In some embodiments, the component 108 can be made of steel, stainless steel, aluminum, alloys thereof, or the like. In some embodiments, the fastener 100 and the component 108 can be the same material. In some embodiments, the fastener 100 can be made of a harder material than the component 108. In some embodiments, the fastener 100 can be made of a harder material than the receiving threads 118 of the component 108.

Additional suitable materials for the fastener 100 and the component 108 are described in U.S. Pat. Nos. 8,465,240 and 11,519,452, the entire contents of which are hereby incorporated by reference.

In some embodiments, the threaded portion 112 can include threads 114 that are non-standard. That is, the thread density or thread pitch may not conform to standard thread sizes such as, but not limited to, those defined by the Unified Thread Standard (UTS). In some embodiments, the threads 118 of the component 108 may be standard. In some embodiments, the threads 118 of the component 108 may be non-standard. In some embodiments, clearance is present between the plurality of protrusions 116 and the threads 118 to prevent contact between the protrusions 116 and the threads 118 when threading the fastener 100 to the component 108. In such embodiments, the threaded portion 112 can be threaded to the threads 118 of the component 108 without the plurality of protrusions 116 engaging or embedding into a surface of the threads 118.

In some embodiments, the threaded portion 112 can include threads 114 that are standard. That is, the thread density or thread pitch may conform to standard thread sizes such as, but not limited to, those defined by the UTS. In such embodiments, the threads 118 of the component 108 may be non-standard. In some embodiments, clearance is present between the plurality of protrusions 116 and the threads 118 to prevent contact between the protrusions 116 and the threads 118 when threading the fastener 100 to the component 108. In such embodiments, the threaded portion 112 can be threaded to the threads 118 of the component 108 without the plurality of protrusions 116 engaging or embedding into a surface of the threads 118.

In the illustrated embodiment, the elongated shank 102 includes a smooth cylindrical shank portion 120. The smooth cylindrical shank portion 120 is adjacent to the first end 110. In some embodiments, the opening 104 of the component 108 is configured to receive the smooth cylindrical shank portion 120. In some embodiments, an outside diameter of the smooth cylindrical shank portion 120 is sized and shaped to provide a close tolerance or interference fit with the opening 104, as shown in FIG. 2.

The elongated shank 102 includes a second end 122. The second end 122 is adjacent to the smooth cylindrical shank portion 120. The second end 122 is opposite the first end 110. In some embodiments, at least a portion of the second end 122 includes a grooved feature 124. It is to be appreciated that relative lengths of the first end 110 and the threaded portion 112, the smooth cylindrical shank portion 120, and the second end 122 and grooved feature 124 can vary according to an application of the fastener 100.

In some embodiments, the grooved feature 124 can include at least one groove. In some embodiments, the grooved feature 124 includes one groove. In some embodiments, the grooved feature 124 can include a plurality of grooves. In some embodiments, the grooved feature 124 has a helical profile. In some embodiments, the grooved feature 124 has an annular profile. In some embodiments, the grooved feature 124 can provide a locking feature. In some embodiments, the grooves of the grooved feature 124 are locking grooves. In some embodiments, the grooves of the grooved feature 124 are annular locking grooves. In some embodiments, the grooved feature 124 is configured to receive a collar 126. The collar 126 is configured to maintain a tensile force on the fastener 100 from a side of the application, thereby providing a clamping force to the workpiece 106 in conjunction with the component 108. The collar 126 is configured to be deformed during the installation process forcing the material of the collar 126 into the grooves of the grooved feature 124.

In the illustrated embodiment, the second end 122 also includes a pintail or pull portion 128. The pull portion 128 is adjacent to the grooved feature 124. In some embodiments, the pull portion 128 has a smaller outer diameter than that of the grooved feature 124. In some embodiments, the pull portion 128 includes at least one groove. In some embodiments, the pull portion 128 includes a plurality of grooves. In some embodiments, an installation tool is configured to be mated with the at least one groove of the pull portion 128. Once mated, the installation tool is configured to provide a tensile force on the fastener 100 and to pull the fastener 100 such that the plurality of protrusions 116 come into contact with the threads 118 of the component 108 (e.g., to transition from the un-installed state of FIG. 2 to the installed state of FIG. 3). In some embodiments, the tensile force is maintained by the collar 126. In some embodiments, the tensile force causes the plurality of protrusions 116 to engage corresponding surfaces of the flanks of the threads 118 of the component 108 and is configured to prevent vibration induced loosening of the component 108 from the fastener 100. In some embodiments, the plurality of protrusions 116 can embed into the flanks of the threads 118 of the component 108. FIG. 3 shows the fastener 100 in the installed state including the plurality of protrusions 116 embedded into the threads 118 of the component 108.

With reference to FIG. 2, in a pre-installed state, the threads 114 of the fastener 100 are threaded to the threads 118 of the component 108. In the pre-installed state, the plurality of protrusions 116 may rest on a flank surface 130 of the threads 118. However, in the pre-installed state, the plurality of protrusions 116 are not embedded into the flank surface 130. To transition to the installed state, a tensile force is applied to the fastener 100 so that the plurality of protrusions 116 move toward the component 108 and are embedded into the flank surface 130.

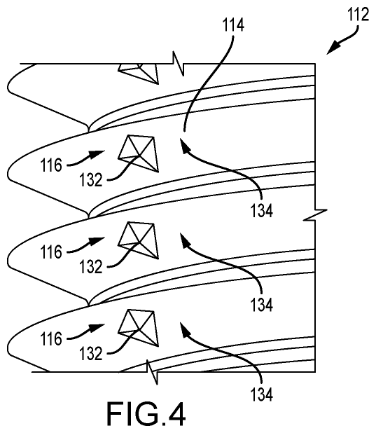

FIG. 4 is a schematic view of the threaded portion 112 of the fastener 100, according to some embodiments. In the illustrated embodiment, the plurality of protrusions 116 are shown. In the illustrated embodiment, the plurality of protrusions 116 are longitudinally aligned with one another with respect to the placement on the threads 114 of the fastener 100. In some embodiments, the plurality of protrusions 116 are not aligned with each other. In some embodiments, more than one location along the threads 114 can include the plurality of protrusions 116. In some embodiments, the plurality of protrusions 116 are manufactured by rolling. It is to be appreciated that other manufacturing methods may be possible within the scope of the present disclosure.

In the illustrated embodiment, the plurality of protrusions 116 include a similar faceted structure. In some embodiments, the plurality of protrusions 116 can have different geometries. In some embodiments, a number of faces on the plurality of protrusions 116 can vary beyond the illustrated four. The plurality of protrusions 116 terminate in a tip 132. The tip 132 can, for example, embed into the threads 118 of the component 108. In some embodiments, the plurality of protrusions 116 can be sized and shaped differently so long as the threads 114 of the fastener 100 are capable of being threaded onto the threads 118 of the component 108 and the plurality of protrusions 116 are capable of engaging with the component 108 to prevent loosening of the connection between the fastener 100 and the component 108. As illustrated, the plurality of protrusions 116 are disposed on a flank surface 134 that faces toward the second end 122 of the fastener 100. In some embodiments, this placement enables the plurality of protrusions 116 to engage the threads 118 of the component 108 in response to a tensile force.

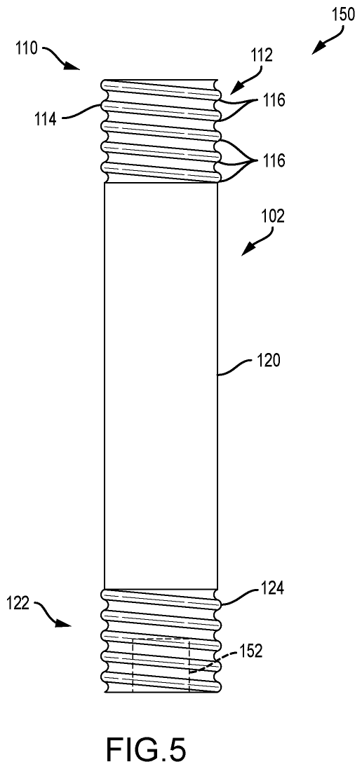

FIG. 5 is a schematic view of a fastener 150, according to some embodiments. The fastener 150 generally includes features that are the same as or similar to the fastener 100 (FIGS. 1-3). Unlike the fastener 100, the fastener 150 does not include the pull portion 128. For simplicity of this disclosure, features of the fastener 150 that are the same as or similar to the features of the fastener 100 will not be redescribed in further detail.

In some embodiments, the fastener 150 is still installed through application of a tensile force. In some embodiments, the second end 122 of the fastener 150 can include an internal bore 152. In some embodiments, the installation tool can include an internal drive rod having threads (not shown) that is configured to be threaded with corresponding threads of the internal bore 152. Once the installation tool is engaged with the threads of the internal bore 152, the installation tool can be used to provide a tensile force to the fastener 100, thereby engaging the plurality of protrusions 116 into the threads 118 of the component 108.

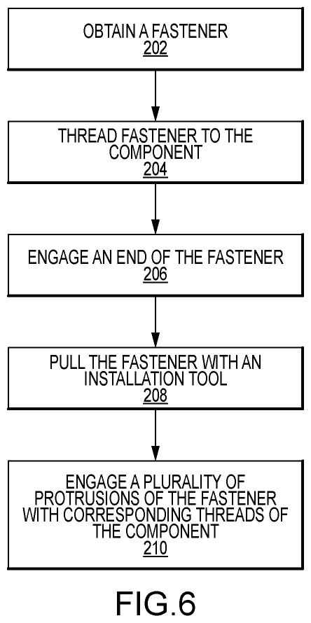

FIG. 6 is a flowchart of a method 200 for installing a fastener (e.g., the fastener 100 of FIG. 1 or the fastener 150 of FIG. 4), according to some embodiments.

At block 202, the method 200 includes obtaining a fastener. The fastener can include the fastener 100, according to some embodiments. The fastener can include the fastener 150, according to some embodiments.

At block 204, the method 200 includes threading the fastener to internal threads of a component. In some embodiments, the component is a nut, and the threads are internal to the nut. In some embodiments, the component can be a bore of a machine or other device, with the bore having internal threads. In some embodiments, after threading the fastener to the internal threads of the component, the fastener is in a pre-installed state as shown and described in accordance with FIG. 2 above.

At block 206, the method 200 includes engaging an end of an elongated shank of the fastener as obtained. In some embodiments, block 206 includes engaging a shank portion of the fastener. In some embodiments, block 206 includes engaging an internal bore of the fastener.

At block 208, the method 200 includes pulling the fastener with an installation tool. That is, the installation tool is used to apply a tensile force to the fastener as obtained.

At block 210, the method 200 includes engaging a plurality of protrusions on the fastener with corresponding threads of the component. In some embodiments, engaging the plurality of protrusions of the fastener with corresponding threads of the component transitions the fastener from the pre-installed state to the installed state, as shown and described in accordance with FIG. 3 above.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A fastener comprising:
an elongated shank comprising:
a first end;
wherein the first end comprises a first threaded portion; and
a second end opposite the first end;
wherein the second end comprises a grooved portion;
wherein the first threaded portion comprises at least one protrusion;
wherein the at least one protrusion is configured to engage at least a corresponding one of internal threads of a component in response to a tensile force applied to the second end.

2. The fastener of claim 1, wherein the first threaded portion is rolled.

3. The fastener of claim 1, wherein the first threaded portion comprises a non-standard threading to provide clearance between threads of the first threaded portion and the internal threads of the component.

4. The fastener of claim 1, wherein the at least one protrusion is disposed on at least one flank side of threads of the first threaded portion.

5. The fastener of claim 1, wherein the internal threads of the component are non-standard to provide clearance between threads of the first threaded portion and the internal threads of the component.

6. The fastener of claim 1, wherein the at least one protrusion comprises a plurality of protrusions on a single flank side of threads of the first threaded portion.

7. The fastener of claim 1, wherein the grooved portion comprises at least one of a helical profile or an annular profile.

8. The fastener of claim 1, wherein the at least one protrusion comprises a plurality of protrusions on a plurality of flank sides of threads of the first threaded portion.

9. The fastener of claim 1, wherein the at least one protrusion is configured to embed into the internal threads of the component.

10. The fastener of claim 1, wherein the at least one protrusion comprises a plurality of protrusions, wherein the plurality of protrusions are not aligned longitudinally with one another.

11. A fastener system comprising:
an elongated shank comprising:
a first end;
wherein the first end comprises a first threaded portion; and
a second end opposite the first end;
wherein the second end comprises a grooved portion;
wherein the first threaded portion comprises at least one protrusion; and
a collar configured to fit over the second end and to provide a clamping force to a workpiece in conjunction with a threaded component;
wherein the at least one protrusion is configured to engage at least a corresponding one of internal threads of the threaded component in response to a tensile force applied to the second end.

12. The fastener system of claim 11, wherein the grooved portion comprises annular threads or helical threads.

13. The fastener system of claim 11, wherein the at least one protrusion is disposed on at least one flank side of threads of the first threaded portion.

14. The fastener system of claim 11, comprising an installation tool configured to engage the second end.

15. The fastener system of claim 11, wherein the first threaded portion comprises a non-standard threading to provide clearance between threads of the first threaded portion and the internal threads of the component.

16. The fastener system of claim 11, wherein the internal threads of the component are non-standard to provide clearance between threads of the first threaded portion and the internal threads.

17. The fastener system of claim 11, wherein the at least one protrusion is configured to embed into the internal threads.

18. The fastener system of claim 11, wherein the at least one protrusion comprises a plurality of protrusions, wherein the plurality of protrusions are not aligned longitudinally with one another.

19. A method of installing a fastener comprising:
obtaining the fastener of claim 1;
engaging the second end of the elongated shank;
pulling the fastener with an installation tool; and
engaging the at least one protrusion with at least a corresponding one of internal threads of the component.

20. The method of claim 19, further comprising deactivating the installation tool to release from the second end of the elongated shank when the fastener has been installed and a plurality of workpieces are clamped together.
